(19) United States
(12) Patent Application Publication
(10) Pub. No.: US 2017/0008238 A1
(43) Pub. Date: Jan. 12, 2017

(54) Method of Manufacturing an Elongated Article, Elongated Article, Obtainable by the Method, and Weight Distributing System, Adapted to be Provided in an Inner Cavity of the Elongated Article

(71) Applicant: WESP HOLDING B.V., Eindhoven (NL)

(72) Inventors: Marc Marinus Johannes Leonardus Giebels, Geldrop (NL); Haro Egbert Georg Roderik Van Panhuys, 's-Hertogenbosch (NL); Johan Erhard Sluiters, Lieshout (NL)

(21) Appl. No.: 15/117,921

(22) PCT Filed: Feb. 11, 2015
(86) PCT No.: PCT/NL2015/050090

§ 371 Date: Aug. 10, 2016

(30) Foreign Application Priority Data
Feb. 11, 2014 (NL) 2012239

(51) Int. Cl. B29C 70/46; B29C 70/16; A63B 60/42; A63B 59/70; A63B 59/55; B29C 70/34; B29C 35/02

(52) U.S. Cl. CPC B29C 70/462; B29C 70/34; B29C 70/16; B29C 35/02; A63B 59/70; A63B 59/55; A63B 60/42; B29L 2031/52

(57) ABSTRACT

The invention relates to a method of manufacturing an elongated article having a shaft and a functional head section. The method includes the steps of providing a dimensionally stable core mandrel; overlaying first reinforcing fibers onto the core mandrel to form one or more first wall parts; providing at least one shaping element to the overlaid core mandrel; overlaying second reinforcing fibers onto the core mandrel and the at least one shaping element to form one or more second wall parts; and providing a matrix material and consolidating the matrix material. The core mandrel is provided to form an elongated article having a well defined inner cavity. Overlaying fibers is preferably performed by in-situ braiding. The cross-section of the elongated article includes fiber reinforced wall parts that impart stiffness to the article. The inner cavity may be filled with weight distributing element(s).

### FIELD OF THE INVENTION

The invention relates to a method of manufacturing an elongated article having a shaft and a functional head section. The invention further relates to an elongated article, obtainable by the method. The invention finally relates to a weight distributing system, adapted to be provided in an inner cavity of the elongated article.

### BACKGROUND OF THE INVENTION

The elongated articles of the invention comprise a shaft bridging a distance between a grip section at one end of the shaft and a functional head section provided at another end of the shaft. The head section is functional in the sense that it is configured to perform a function. In sport articles, this function comprises but is not limited to contacting or hitting an object, such as a ball, a puck, a shuttle, a water or floor surface, and the like, or attaching an object, such as a fishing line for instance. In health care articles, such as in walking aids, the function may be offering support. The grip section may be provided with a cover for ease of handling.

Several methods of manufacturing an elongated article, such as sport articles, are applied today.

One known method of manufacturing a sport article for instance comprises providing a solid mandrel, for instance made of wood, and overlaying this core mandrel with reinforcing fibers or prepreg material, optionally applying a matrix material and consolidating the matrix material to form the sport article. Although a sport article obtained by such method generally shows adequate stiffness and strength, its weight is often too high.

Another known method of manufacturing a sport article provides an inflatable mandrel, for instance made of a plastic foil, and overlays this core mandrel with reinforcing fibers, applies a matrix material and consolidates the matrix material to form the sport article. This method may also be combined with the previous known method. Although a sport article obtained by such method generally has a relatively low weight, it shows inadequate stiffness and strength.

The known methods described above are time-consuming and are not very reproducible, since they are typically carried out by hand. The known methods further produce elongated articles that are not customized, i.e. the articles produced are poorly adapted to personal wishes or capabilities.

The aim of the present invention is to provide an improved method of manufacturing an elongated article, which method provides an elongated article with at least a similar performance for a lower weight, and further allows customizing the article according to a user's wishes.

### SUMMARY OF THE INVENTION

In a first aspect of the invention, the above and other aims are provided by a method in accordance with claim 1. The method in particular comprises the steps of providing a dimensionally stable core mandrel; overlaying first reinforcing fibers onto the core mandrel to form one or more first wall parts; providing at least one shaping element to the overlaid core mandrel; overlaying second reinforcing fibers onto the core mandrel and the at least one shaping element to form one or more second wall parts; providing a matrix material and consolidating the matrix material; the core mandrel being provided to form an elongated article having a well defined inner cavity. According to the invention, the core mandrel or a part of the core mandrel is removed after the step of providing a matrix material and consolidating the matrix material, in order to form the inner cavity.

According to the invention, a core mandrel is provided to form an article having a well defined inner cavity. A well defined inner cavity is defined in the context of the present invention as an inner cavity having dimensions that do not deviate between cross-sections of the elongated article by more than 10%, more preferably by more than 5%, and most preferably by more than 2%. The dimensions of the inner cavity may comprise one of a height, a width, a diameter or radius for instance. In an embodiment of the invention, the core mandrel has a constant cross-section along the substantially whole length of the elongated article.

An elongated article in the context of the present application comprises any article having a shaft and a functional head section, preferably with a length to transverse dimension ratio of more than 2, more preferably more than 5, and most preferably more than 10.

In an embodiment of the invention, a hollow core mandrel is provided with a well defined inner cavity. In such case, the core mandrel is provided with an internal part that when removed forms a well defined inner cavity. Another part of the core mandrel in this embodiment remain part of the manufactured elongated article and the well defined inner cavity of the core mandrel then also defines the well defined inner cavity of the elongated article.

According to the invention, a method is provided wherein the core mandrel is provided with a well defined outer surface and the core mandrel is removed, preferably after having provided a matrix material and, more preferably, after having consolidated the matrix material. Removal of the core mandrel may for instance be performed by sliding it out of one end of the elongated article. Other methods may include providing a collapsible core mandrel, for instance by providing a core mandrel with flexible skin and a filler, which filler may be air or a fluid, and removing the filler from the skin, or by providing a core mandrel having interlocking parts that may be disassembled.

The method in accordance with the invention provides a dimensionally stable core mandrel to form an elongated article having a well defined inner cavity. In an embodiment, one core mandrel is provided. In another embodiment, two or more core mandrels are provided that are overlaid with the first and/or second reinforcing fibers to form a elongated article having two or more well defined inner cavities.

A well defined outer surface of the core mandrel is defined in the context of the present invention as an outer surface having dimensions that do not deviate between cross-sections of the elongated article by more than 10%, more preferably by more than 5%, and most preferably by more than 2%. The dimensions of the outer surface may comprise one of a height, a width, a diameter or radius for instance. In an embodiment of the invention, the cross-section of the core mandrel is rectangular, by which is meant that the inner cavity and/or the outer surface of the core mandrel has a rectangular cross-section. However, the cross-section of the core mandrel may have any other shape.

According to the invention, the core mandrel is dimensionally stable, which, in the context of the present application, means that the dimensions of the core mandrel are not changing substantially at the pressure and temperature levels applied in the method. A change is considered not substantial when less than 10%, more preferably less than 5%, most preferably less than 2%.

Suitable elongated articles comprise but are not limited to sport articles, such as fishing rods, rowing oars, field hockey sticks, ice hockey sticks, baseball bats, crickets bats, tennis, lacrosse and badminton rackets, and the like, a field hockey stick being preferred. The functional head section of the elongated article may be a blade, such as in ice hockey articles, or a curl, such as in field hockey articles. The shaft and functional head section of the elongated article may be formed apart and joined later, or formed in one piece, the latter being the preferred method. Other exemplary elongated articles comprise health care articles, such as walking sticks for instance. The functional head section in such embodiments provides support on a surface.

In an embodiment of the invention, a method is provided wherein the core mandrel is provided with at least one shaping element before overlaying the first reinforcing fibers. This embodiment allows to vary the shape of the first wall parts for a given core mandrel.

The method in accordance with the invention allows manufacturing an elongated article with a relatively low weight. A particularly useful embodiment provides a method wherein one or more shaping elements are removed from the elongated article, preferably after having provided a matrix material and, more preferably, after having consolidated the matrix material. The thus formed cavities may be filled with materials, such as weight distributing materials, if desired.

The core mandrel in accordance with the invention may extend over a part of a length dimension of the elongated article only. As will become apparent further below, it has advantages in an embodiment of the method when the core mandrel substantially extends from a grip end of the shaft to an outer end of the functional head section. This allows providing the elongated article with a well defined cavity substantially all along its length, in an embodiment of the method wherein the inner cavity substantially extends from a grip end of the shaft to an outer end of the functional head section. This can be achieved either by providing the core mandrel with an inner cavity that extends from a grip end of the shaft to an outer end of the functional head section, or by providing a core mandrel that extends from a grip end of the shaft to an outer end of the functional head section, and removing the core mandrel.

Overlaying the core mandrel, optionally provided with one or more shaping elements, with the first and/or second reinforcing fibers may be performed by any method known in the art, such as, but not limited to, hand lay up of fibers, pre-impregnated fibers (prepregs), fabrics and/or braided structures, filament and/or pre-impregnated tow (towpreg) winding methods, pultrusion, and any combination of these methods. It may be possible to use comingled fibrous structures that may comprise two different fibers, one of which may be a fibrous matrix material and the other a reinforcing fiber. The (already partly) overlaid core mandrel may be overlaid with one or more layers of reinforcing fibers, depending on needs.

A particularly useful embodiment of the invention provides a method wherein overlaying with the first and/or second reinforcing fibers is performed by in situ braiding the reinforcing fibers onto the core mandrel or overlaid core mandrel. This embodiment in particular provides a method of manufacturing an elongated article that is fast, reliable, and reproducible, and yet yields desirable mechanical properties and performance In situ-braiding may be performed on one core mandrel to produce one elongated article, but is preferably performed on a plurality of core mandrels, arranged in series, to produce a plurality of elongated articles in one braiding operation. In an embodiment of the method, the in-situ braiding is performed from a grip end of the shaft to an outer end of the functional head section and/or vice versa.

The cross-sectional geometrical shape of the core mandrel and/or, optionally also the geometrical shape of shaping elements provided on the core mandrel before overlaying the first reinforcing fibers, defines the geometrical shape of the first wall part or parts, as well as their exact position in a cross-section of the elongated article. A useful embodiment of the invention provides a method wherein the functional head section of the elongated article comprises a contacting surface, and a first wall part extends perpendicular to said contacting surface.

The shaping elements may comprise foam elements, that are foamed in-situ or foamed prior to molding. Other suitable shaping elements comprise inflatable elements that may be filled. Shaping elements are conveniently made from polymeric materials, and may be (locally) reinforced, for instance with reinforcing fibers.

The first and/or second reinforcing fibers may comprise glass fibers, carbon and graphite fibers, metal fibers, drawn polymeric fibers, such as aramid fibers, PBO fibers (Zylon®), M5® fibers, ultrahigh molecular weight polyethylene or polypropylene fibers, as well as natural fibers, such as flax and wood fibers, and/or combinations of said fibers. The first and second reinforcing fibers may be the same, but this is not necessary. They may also be combined with a matrix material, for instance when using towpregs.

The core mandrel may be made of a metal but is preferably made of a polymer such as a polyolefin, of which low density polyethylene (LDPE), polyoxymethylene (POM) and/or polyvinylidene difluoride (PVDF) are preferred. A core mandrel of cured monomers may also be used.

In an embodiment of the method according to the invention, the matrix material comprises a thermosetting resin that is consolidated by curing. Suitable examples include epoxy resins, unsaturated polyester or vinylester resins, polyurethane resins, and the like. In another embodiment of the method, the matrix material comprises a thermoplastic polymer that is consolidated by cooling. Suitable examples comprise polyolefin's, such as polyethylene or polypropylene, styrene polymers such as polystyrene or ABS, thermoplastic polyurethanes, and the like. Combinations of thermosetting and thermoplastic materials may also be used. The matrix material may be provided as a separately applied constituent, or may be incorporated in an intermediate product, such as a prepreg or towpreg.

The method in accordance with the invention provides an elongated article having a well defined cavity, which preferably extends substantially along the whole length of the elongated article. The well defined cavity provides the elongated article with a desirably high stiffness and strength, and, in a useful embodiment of the invented method, allows to provide the inner cavity with at least one weight distributing element. The at least one weight distributing element may be provided in any inner cavity provided in the elongated article. It is for instance possible to form the inner cavity by providing a core mandrel having an inner cavity, in which embodiment the at least one weight distributing element is provided in said cavity of the core mandrel. In another embodiment, the inner cavity is formed by removing a core mandrel after forming, in which embodiment the at least one weight distributing element is provided in the cavity formed by the removed core mandrel. In yet another embodiment, the at least one weight distributing element is provided in an inner cavity, formed by removal of at least one shaping element.

The weight distribution elements may be made of a metal, but a polymeric weight distributing element is preferred. Polymers to be used in the weight distribution elements comprise all suitable for the purpose polymers known to one skilled in the art. Preferred polymers comprise high density polyethylene (HDPE), polyoxymethylene (POM) and/or polyvinylidene difluoride (PVDF). The higher density materials are preferably used in the functional head section of the elongated article.

The weight distribution element may be provided in one piece that preferably extends along the substantially complete length of the elongated article. In this embodiment, weight is distributed by varying the density of the weight distribution element along its length. This can for instance be done by applying different materials along the element's length, or by providing holes or cavities in the weight distribution element.

In an embodiment of the method according to the invention, weight distributing elements are interconnected to form a string of interconnected weight distributing elements. The length of the weight distributing element can be varied by changing the number of interconnected elements in the string. The properties of each element can be chosen in function of the desired weight distribution, and an embodiment of the invention provides a method wherein weight distributing elements with a different density and/or shape are provided in the inner cavity.

The cross-sectional dimensions of the weight distributing element or elements are chosen such that the elements may be incorporated in the inner cavity of the elongated article. In order to at least partly prevent noise generation, a preferred method provides at least one weight distributing element of which a cross-sectional dimension is about equal to a cross-sectional dimension of the inner cavity. More preferably, the cross-section of the at least one weight distributing element is about equal to the cross-section of the inner cavity. A dimension is considered about equal to another dimension when deviating less than 10%, more preferably less than 5% from the other dimension.

In another useful embodiment, the at least one weight distributing element is used in the method of the invention as the core mandrel.

In an embodiment of the method, the weight distributing elements in the string are interconnected through a hook-like connection. Such a connection helps to accommodate a curvature in the elongated article and provides a connection between elements that does not add unnecessary weight to the elongated article. The connection also allows to withdraw a string of weight distributing elements from the inner cavity of the elongated article. The weight distribution elements themselves are preferably of relatively low stiffness to accommodate a curvature in the elongated article.

A particularly suitable embodiment of the method according to the invention provides a string of weight distributing elements in which the hook-like connection is obtained by interlocking cantilevered end sections of adjacent weight distributing elements.

Another embodiment provides a method wherein a part of the at least one weight distributing element is slightly oversized with respect to the cross-section of the inner cavity, by which is meant that the height or width dimension of said part is at most 10% larger, more preferably at most 5% larger, than the corresponding height or width dimension of the inner cavity. A particularly useful embodiment provides a method wherein a part of cantilevered end sections of weight distributing elements is slightly oversized with respect to the cross-section of the inner cavity. Said part in this embodiment acts as a resilient pressure element.

Another embodiment of the invention provides a method wherein the at least one weight distributing element extends from a grip end of the shaft to an outer end of the functional head section. This embodiment offers increased flexibility in distributing weight.

In yet another embodiment of the method according to the invention, at least one weight distributing element comprises a stack of lamellae. Such elements are readily provided in an inner cavity of an elongated article exhibiting a rather large curvature, such as encountered in the curl-shaped functional head section of a field hockey stick for instance. A weight distributing element according to this embodiment conforms to said curvature by mutual shearing of the lamellae. A preferred embodiment uses a weight distributing element in which the lamellae originate from a common solid part of the element. This effectively holds the lamellae together. Another preferred embodiment uses a weight distributing element in which the lamellae are made of different materials. This allows to distribute weight in a cross direction of the weight distributing element.

Another aspect of the invention relates to an elongated article, that is obtainable by a method according to the invention. The elongated article comprises a shaft and a functional head section, preferably configured to contact an object, and further comprises a well defined inner cavity that preferably substantially extends from the grip end of the shaft to the outer end of the functional head section.

The method of the invention allows to manufacture a novel elongated article which, in an embodiment, has an inner cavity, the dimensions of which do not deviate between cross-sections of the elongated article by more than 10%, more preferably by more than 5%, and most preferably by more than 2%.

The well defined inner cavity of the elongated article offers the opportunity to provide an elongated article with weight distributing elements in the inner cavity. The weight distributing elements preferably extend along substantially the whole length of the elongated article, in particular extending from a grip end of the shaft of the elongated article to an outer end of the functional head section.

An elongated article according to the invention shows unprecedented mechanical properties, in particular flexural stiffness and strength.

A final aspect of the invention relates to a weight distributing system, adapted to be provided in an inner cavity of an elongated article in accordance with the invention, the system comprising a string of interconnected weight distributing elements. The weight distributing elements in the string are preferably interconnected through a hook-like connection, and, in another preferred embodiment, comprise a stack of lamellae.

### BRIEF DESCRIPTION OF THE FIGURES

The invention will now be described in more detail by reference to the accompanying figures and a description of specific embodiments, without however being limited thereto. In the figures:

FIGS. 1A-1F schematically show a number of steps of the method of manufacturing a hockey article in accordance with an embodiment of the invention;

FIG. 2 schematically shows a perspective view of a braiding device to be used in an embodiment of the present invention;

FIGS. 3A-3E schematically show a number of steps of the method of manufacturing a hockey article in accordance with another embodiment of the invention;

FIGS. 4A-4D schematically show a number of steps of a method to obtain a reinforced shaping element in accordance with the invention;

FIGS. 5A-5D schematically show a perspective view of weight distributing elements in accordance with embodiments of the invention;

FIG. 6 schematically shows a perspective view of a weight distributing system in accordance with an embodiment of the invention; and

FIG. 7 schematically shows a perspective view of the weight distributing system of FIG. 6 in a shape that conforms to the shape of a core mandrel 1, or inner cavity in which the string is received.

### DETAILED DESCRIPTION OF EMBODIMENTS

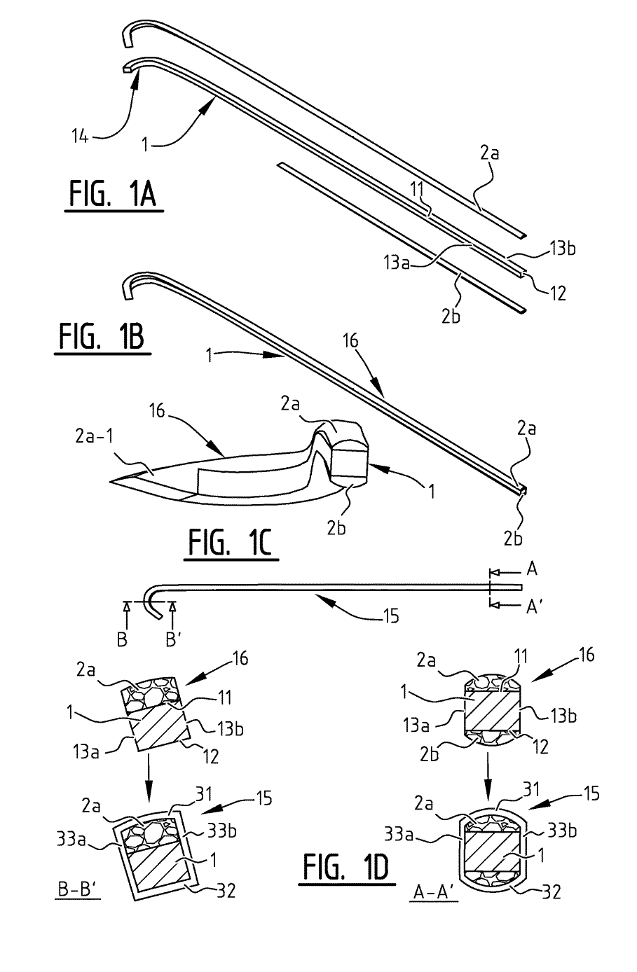

With reference to FIGS. 1A-1F an embodiment of the method according to the invention is shown, in particular for manufacturing a field hockey stick 10. The field hockey stick 10 shown in FIG. 1F comprises a shaft 20 and a curled head section 30. The head section 30 is configured to hit a hockey ball, for which purpose the head section 30 is provided at one side with a relatively flat hitting surface 30a, as shown in FIG. 1F. The opposite (or backhand side) side usually comprises a curved surface 30b. The hockey stick 10 is at a non-hitting end of the shaft 20 provided with a grip section 20a, which is for comfort provided with a wrapped tape and optionally a foamed grip.

In a first step of the manufacturing method, shown in FIG. 1A, a dimensionally stable core mandrel 1 is provided in the form of a high density polyethylene (HDPE) or POM polymer rod with a constant cross-section along the length direction 40 of the field hockey stick 10. Although the core mandrel 1 may be provided with a well defined inner cavity, the embodiment shown employs a solid core mandrel 1. The cross-section of the core mandrel 1 is rectangular and defines an upper surface 11, a lower surface 12, and two side surfaces (13a, 13b). The core mandrel 1 substantially extends from the grip end 20a of the shaft 20 to an outer end 31 of the head section 30, and is therefore provided with a curled section 14 that corresponds to the curled head section 30 of the hockey stick 10. In order to define a well defined inner cavity of the field hockey stick 10, the core mandrel 1 has well defined outer surfaces (11, 12,13a, 13b). The cross-dimensions of the core mandrel 1 thereto do not deviate between cross-sections of the mandrel 1 by more than 10%, more preferably by more than 5%, and most preferably by more than 2%.

In a next step of the method, the core mandrel 1 is provided with two shaping elements (2a, 2b), as shown in FIG. 1A in exploded view and in FIG. 1B in assembled view, to form an intermediate product 16. Shaping element 2a is provided in contact with upper surface 11 and extends in the length direction 40 of the field hockey stick 10 along substantially its complete length, i.e. from the grip section 20a to about the outer end 31 of the head section 30. Shaping element 2b is provided in contact with lower surface 12, extends in the length direction 40 of the field hockey stick 10 along a part of the length only, and is tapered down in the direction of the head section 30. As shown in FIG. 1C, the shaping element 2a forms a capped end portion 2a-1 of the core mandrel 1. The shaping elements (2a, 2b) in the embodiment shown comprise polyurethane foam elements that have been foamed in-situ. They may also be foamed prior to molding and milled or cut into the desired shape.

FIG. 1D shows another step of the method in which the assembly of core mandrel 1 and shaping elements (2a, 2b) is overlaid with first reinforcing fibers to form an intermediate product 15 having first wall parts (31, 32, 33a, 33b). Overlaying is conveniently performed by in-situ braiding, as will be described further below. The first wall parts comprise an upper wall part 31, a lower wall part 32, and two side wall parts (33a, 33b), but form a continuous structure around core mandrel 1 and shaping parts (2a, 2b).

FIG. 1E shows yet another step of the method in which the overlaid structure 15 of FIG. 1D is provided with additional shaping elements (4a, 4b), as shown in FIG. 1E in exploded view. Shaping element 4a is provided in contact with the left hand first wall part 33a and extends in the length direction 40 of the field hockey stick 10 along substantially its complete length, i.e. from the grip section 20a to about the outer end 31 of the head section 30. Shaping element 4b is provided in contact with the right hand side first wall part 33b, and also extends in the length direction 40 of the field hockey stick 10 along substantially its complete length. As shown in the cross-sections of FIG. 1F, the shaping elements (4a, 4b) are applied at both sides of the overlaid structure 15 in contact with side wall parts (33a, 33b), and leave the upper and lower first wall parts (31, 32) uncovered. The shaping elements (4a, 4b) may also comprise polyurethane foam elements for instance.

FIG. 1F shows yet another step of the method in which the assembly of core mandrel 1 and shaping elements (2a, 2b, 4a, 4b) is overlaid with second reinforcing fibers to form a product 10, having second continuous wall part 41, again conveniently formed by in-situ braiding of reinforcing fibers, such as carbon or graphite fibers for instance. The second wall part 41 comprises a relatively flat lower wall part 41-1 that is in immediate contact with lower first wall part 32 to form a stiff and elastic hitting surface 30a. The wording elastic here means that only a minor amount of energy, or nil, is dissipated. The stiffness of the hitting surface 30a is also provided by first wall parts (33a, 33b) that extend perpendicular to said hitting surface 30a.

In a further step of the method, a matrix material such as an epoxy resin is provided to the assembly and cured at a pressure and temperature level in accordance with the suppliers instructions. Typical pressures may range from 1 bar to more than 7 bar, whereas typical temperatures may range from room temperature up to 175° C. and more. The material of the core mandrel 1 is selected such that its dimensions do not substantially change at the pressure and temperature levels used in the method.

In another step of the method the core mandrel 1 is finally removed from the formed hockey stick 10. Removal can be performed by sliding the core mandrel 1 out of the hockey stick 10 through an opening at the grip end section 20 for instance. A hockey stick 10 is now formed having a well defined inner cavity with internal dimensions that conform to the outer dimensions of the removed core mandrel 1. In the embodiment shown in FIGS. 1A to 1F, the shaping elements (2a, 2b, 4a, 4b) remain in the manufactured field hockey stick 10. In other embodiments, some of the shaping elements (2a, 2b, 4a, 4b) may be removed from the hockey stick 10, for instance shaping element 2b, in order to save additional weight.

In useful embodiments of the method according to the invention, overlaying with the first and/or second reinforcing fibers is performed by in situ braiding the reinforcing fibers onto the core mandrel 1, optionally supplemented with shaping elements (2a, 2b, 4a, 4b).

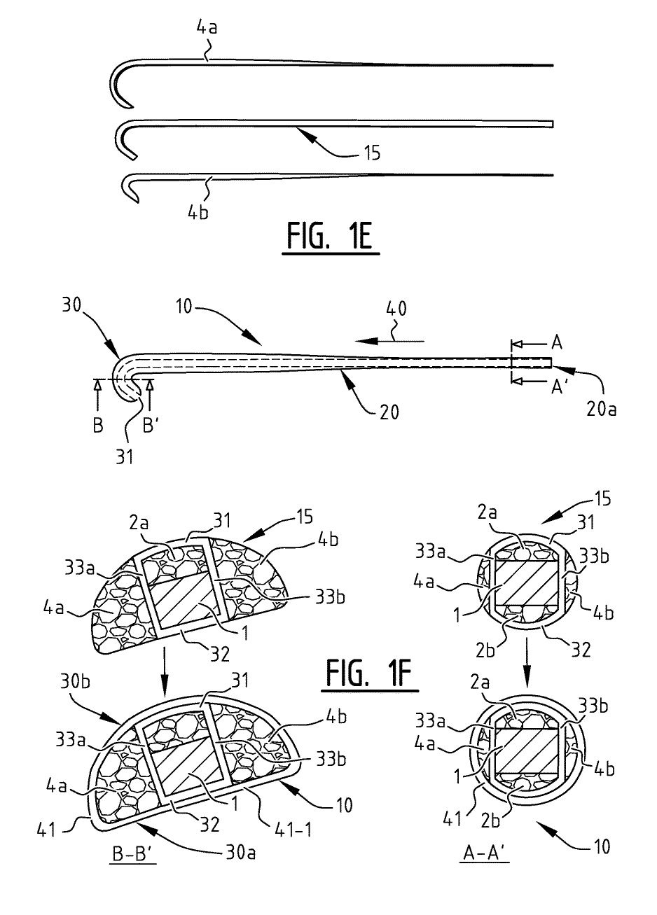

With reference to FIG. 2, a useful device 5 for braiding the first and/or second reinforcing fibers (not shown) onto core mandrels 1 (or intermediate products 15-17, or product 10) to obtain a braided field hockey stick 20 is shown. Other devices may also be used. Device 5 comprises a braiding machine 51 with a track plate 53 that carries a number of fiber bobbin carriers 54, provided with reinforcing fibers, and a forming ring 52, attached to the track plate 53. The braiding machine 51 encloses a looped braiding mandrel, comprising a number of core mandrels 1, intermediate products (15-17) or products 10, positioned in series, and is adapted to braid layers of reinforcing fibers around the braided mandrel. A fully overlaid core mandrel 1 corresponds to a hockey stick 10. Positioning means in the form of a robot 55 effectuate relative movement of the mandrel and the braiding machine 51 during braiding. The robot 55 essentially consists of a turntable 56 around which a pivoting arm 57 can be rotated. Pivoting arm 57 is at an end thereof provided with gripping means 58 that act upon the braiding machine 51. The robot 55 is connected to a computer (not shown), which contains the data to steer the robot 55, in particular pivoting arm 57 and gripping means 58 along any desirable path. The looped mandrel formed by mandrels (1, 15-17, or 10) positioned in series is held in a stationary position by support poles 59 provided with gripping means. The braiding machine 51 is manipulated by the robot 55 about the mandrel along a path, determined by the computer, while simultaneously rotating the bobbins 54 around a central axis of the track plate 53 and forming ring 52. In this way a plurality of reinforcing fibers is positioned onto the mandrel to produce several fiber layers that form a continuous looped braided structure. In order for the braiding machine 51 to pass a support pole 59, support poles 59 may be temporarily placed in a tilted position, as shown in FIG. 2 by pole 59a.

In an exemplary embodiment, the mandrel formed by the series of mandrels (1, 15-17 or 10) is braided with high strength carbon fibers. The multilayered fibrous braided structures thus created form the first (31, 32, 33a, 33b) and second (41, 41-1) wall parts of the hockey stick 10. The braided structures extend from a grip end of the shaft of each mandrel (1, 15-17 or 10) to an outer end of the head section of each mandrel (1, 15-17 or 10) and form a continuous looped structure. The braided structures are then divided to form separate hockey sticks 10 and impregnated with a matrix material and consolidated.

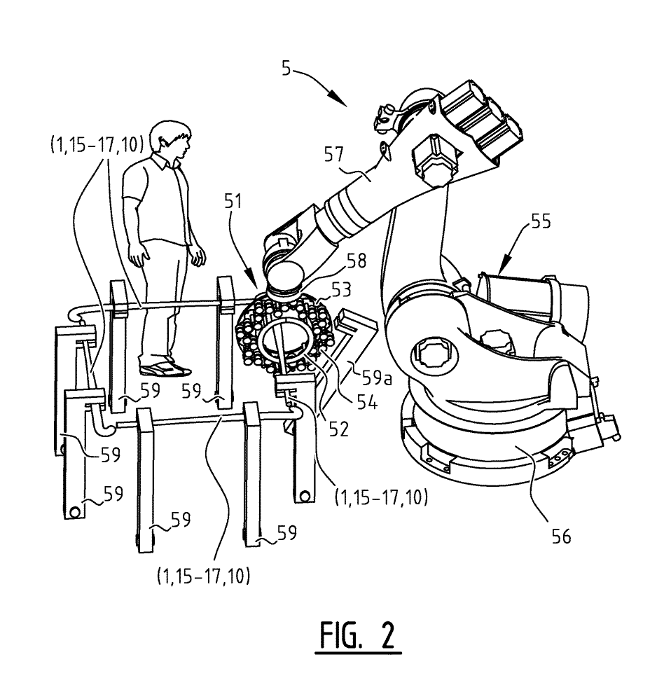

With reference to FIGS. 3A-3E another embodiment of the method for manufacturing a field hockey stick 10 according to the invention is shown.

In a first step of the manufacturing method, shown in FIGS. 3A and 3B, a dimensionally stable solid core mandrel 1 is provided. The high density polyethylene (HDPE) or POM polymer rod has a constant cross-section along the length direction 40 of the field hockey stick 10. The cross-section of the core mandrel 1 is rectangular and defines an upper surface 11, a lower surface 12, and two side surfaces (13a, 13b). The core mandrel 1 substantially extends from the grip end 20a of the shaft 20 to an outer end 31 of the head section 30, and is provided with a curled section 14 that corresponds to the curled head section 30 of the hockey stick 10. In order to define a well defined inner cavity of the field hockey stick 10, the core mandrel 1 has well defined outer surfaces (11, 12,13a, 13b). The cross-dimensions of the core mandrel 1 thereto do not deviate between cross-sections of the mandrel 1 by more than 10%, more preferably by more than 5% and most preferably by more than 2%.

FIG. 3C shows a next step of the present embodiment in which the core mandrel 1 of FIGS. (3A, 3B) is overlaid with first reinforcing fibers to form first wall parts (61, 62, 63a, 63b), which is conveniently performed by in-situ braiding, as was described above. The first wall parts comprise an upper wall part 61, a lower wall part 62, and two side wall parts (63a, 63b), but form a continuous structure around the core mandrel 1.

FIG. 3D shows yet another step of the present embodiment in which the overlaid structure 15 of FIG. 3C is provided with a shaping element 6, as shown in FIG. 3D in exploded view to form an intermediate product 17. Shaping element 6 is at the grip end section 20a provided around the overlaid structure 15 in contact with the left hand first wall part 63a, the right hand first wall part 63b, the upper first wall part 61 and the lower first wall part 62, and extends in the length direction 40 of the field hockey stick 10 along substantially its complete length, i.e. from the grip section 20a to about the outer end 31 of the head section 30. Shaping element 6 at the outer end 31 is provided in contact with the side wall parts (63a, 63b) and the upper wall part 61 only. The shaping element 6 may comprise a polyurethane foam for instance.

FIG. 3E shows yet another step of this embodiment in which the intermediate product 17 (the assembly of core mandrel 1 and shaping element 6) is overlaid with second reinforcing fibers to form a second continuous wall part 71, again conveniently formed by in-situ braiding of reinforcing fibers, such as carbon or graphite fibers for instance. The second wall part 71 comprises a relatively flat lower wall part 71-1 that is in immediate contact with lower first wall part 62 to form a stiff and elastic hitting surface 30a.

As already described above, further steps of the method comprise providing and consolidating a matrix material and removal of the core mandrel 1 from the formed hockey stick 10. A hockey stick 10 is again formed having a well defined inner cavity with internal dimensions that conform to the outer dimensions of the removed core mandrel 1. In the embodiment shown in FIGS. 3A to 3E, the shaping element 6 remains in the manufactured field hockey stick 10, but it may also be removed from the hockey stick 10 to save additional weight.

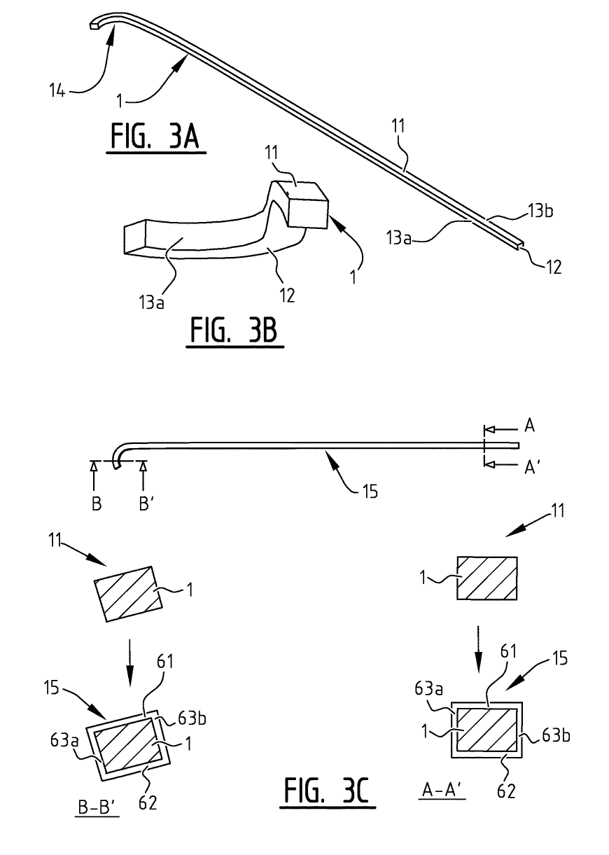

FIGS. 4A-4D shows the possibility of adding local reinforcements to a shaping element 8 and/or to a shaping element provided on a (partly overlaid) core mandrel. FIG. 4A shows a shaping element 8, a section 81 of which is reduced in dimensions, for instance by rejuvenating. The cross-section of the shaping element 8 changes along the length of the hockey stick 10, as appears from cross-sections A-A′ and B-B′ of FIG. 4C.

As shown in FIG. 4C, the reduced dimension part 81 of the shaping element 8 is overlaid with reinforcing fibers to form a wall part 82 around the reduced dimension part 81 of the shaping element 8. As shown in FIG. 4D, the thickness of the wall part 82 is built up to conform with those parts of the shaping element 8 that were not reduced in dimension. The resulting, locally reinforced shaping element 8 of FIG. 4D may then be used in the method according to the invention, as described above in the context of the embodiments shown in FIGS. 1A-1F and 3A-3E. In the present example, the reinforced shaping element 8 of FIG. 4D may for instance be used as shaping element 4a of FIG. 1E and/or shaping element 6 of FIG. 3D.

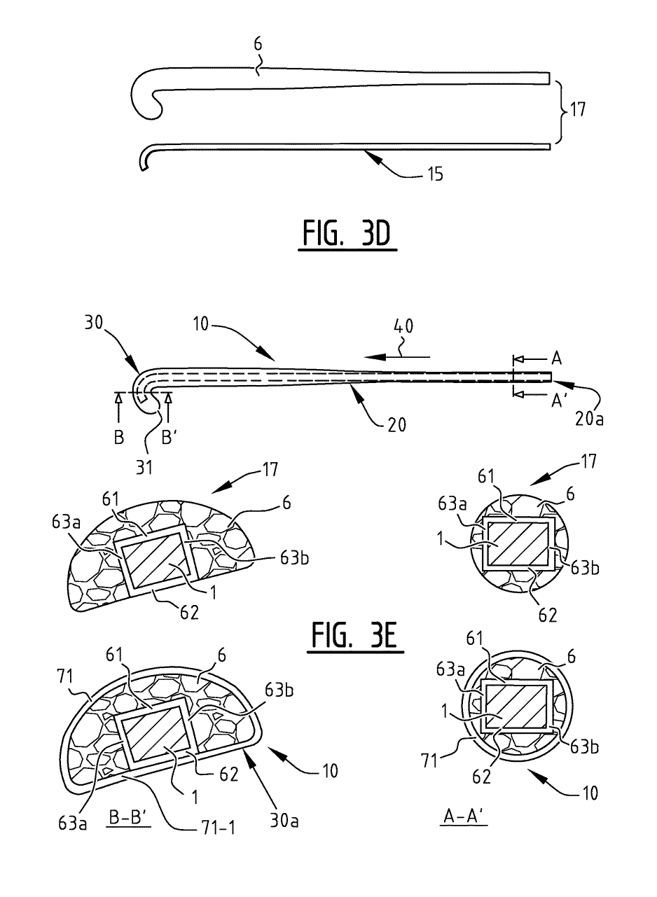

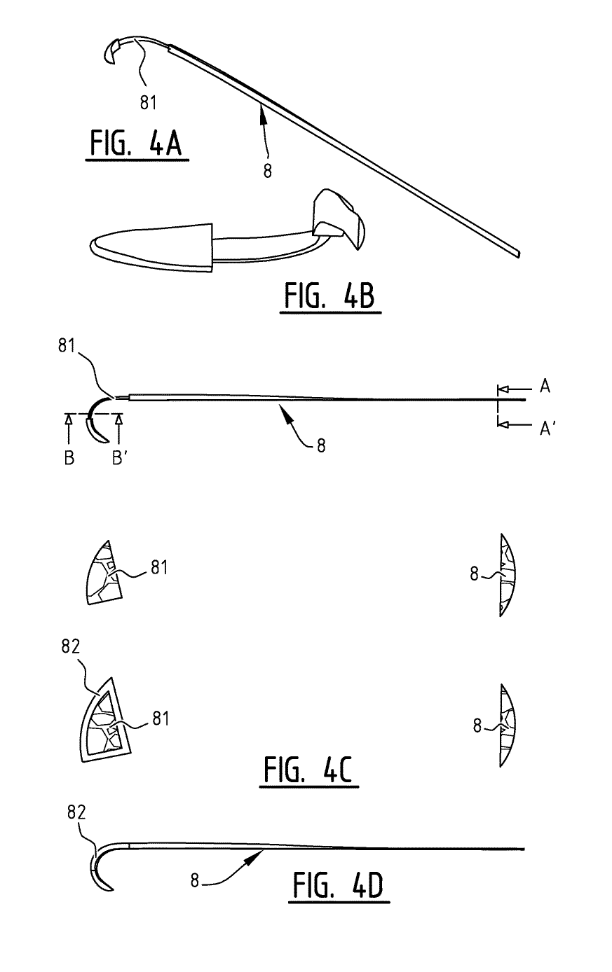

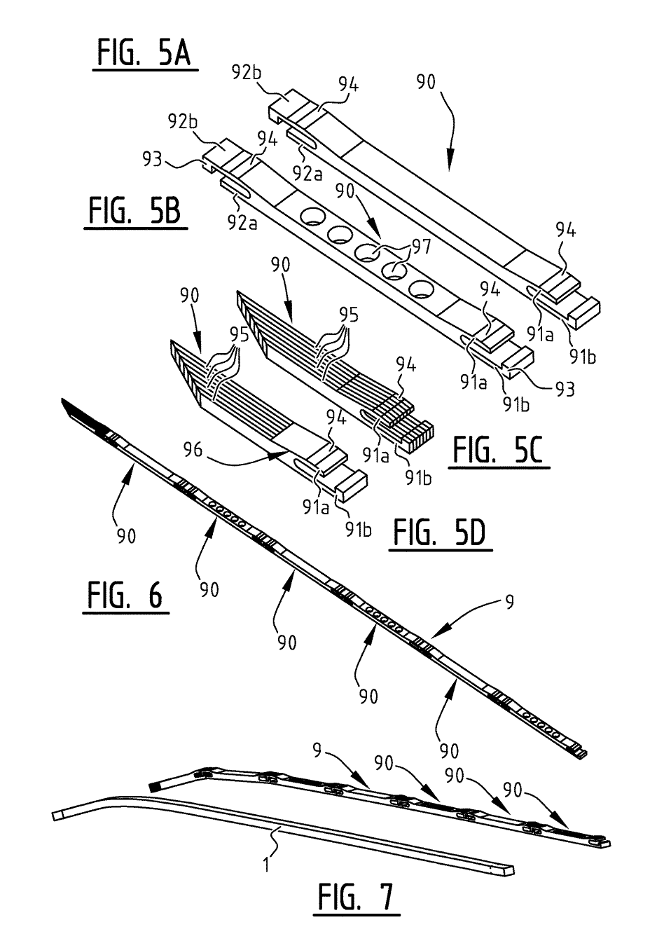

With reference to FIGS. 5A-5D and FIGS. 6 and 7, a weight distributing system 9 in accordance with another aspect of the invention is shown. The weight distributing system 9 comprises a string of interconnected weight distributing elements 90, of which several embodiments are shown in FIGS. 5A-5D. The weight distributing system 9 is adapted to be provided in the well defined inner cavity of the hockey stick 10, which inner cavity corresponds dimensionally with the removed core mandrel 1, as shown in FIG. 7, or with an inner cavity of a hollow core mandrel 1. The string 9 of weight distributing elements 90 in the embodiment shown in FIGS. 6 and 7 extends from the grip end 20a of the shaft 20 to an outer end 31 of the head section 30.

The weight distributing elements 90 in the string 9 are interconnected through a hook-like connection, which, in the embodiments shown in FIGS. 5A-5D comprise first cantilevered end sections (91a, 91b) provided at one end side of a weight distributing element 90 and second cantilevered end sections (92a, 92b) provided at another end side of said weight distributing element 90. The cantilevered end sections (91b, 92b) are each provided with an upstanding end ridge of lip 93 by which two end sections (91b, 92b) may be interlocked to form a string 9, as shown in FIG. 7 for instance. The interlock allows the string 9 to be provided in the inner cavity of the hockey stick 10, but also to pull the string out of the inner cavity without the need for a separate carrier for the weight distributing elements 90.

The cross-sectional dimensions of the weight distributing elements 90 is about equal to a cross-sectional dimension of the inner cavity (or of the core mandrel 1) to avoid any noise generation and/or vibrations when handling the stick 10. As shown in FIGS. 5A-5D, a part 94 of the weight distributing element 90, in particular a part 94 of the cantilevered end sections (91a, 92b), is slightly oversized with respect to the cross-section of the inner cavity. The cantilevered end sections (91a, 92b) in this embodiment act as resilient pressurizing elements that keep the elements 90 in position within the inner cavity.

As shown in the embodiments of FIGS. 5C and 5D, weight distributing elements 90 may be provided comprising a stack of lamellae 95. Such elements 90 are provided at an end of the string 9 (see FIG. 6) and readily conform to the rather large curvature, encountered in the curl-shaped head section 31 of a field hockey stick 10 by mutual shearing of the lamellae 95 in the inner cavity. The embodiment shown in FIG. 5D uses a weight distributing element 90 in which the lamellae 95 originate from a common solid part 96 of the element 90. This effectively holds the lamellae 95 together.

Weight distributing elements 90 with a different density and/or shape may also be provided in the string 9, for instance by providing the elements 90 with holes 97, as shown in FIG. 5B.

The method according to the invention allows to produce a sport stick or other elongated article having a well defined inner cavity that, in a preferred embodiment, substantially extends from the grip end of the shaft to the outer end of the head section of the sport stick, and allows to accept the string 9 of weight distributing elements 90.

The sport stick thereto preferably has dimensions of the inner cavity thereof that do not deviate between cross-sections of the sport stick by more than 10%, more preferably by more than 5%, and most preferably by more than 2%.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-30. (canceled)

31. A method of manufacturing an elongated curved article having a shaft and a functional head section, the method comprising the steps of:
a) providing a dimensionally stable core mandrel, wherein the core mandrel substantially extends from a grip end of the shaft to an outer end of the functional head section;
b) overlaying first reinforcing fibers onto the core mandrel to form one or more first wall parts;
c) providing at least one shaping element to the overlaid core mandrel;
d) overlaying second reinforcing fibers onto the core mandrel and the at least one shaping element to form one or more second wall parts;
e) providing a matrix material and consolidating the matrix material;
wherein the core mandrel is provided to form an elongated curved article having a well defined inner cavity, wherein the method further comprises f) removing the core mandrel or a part of the core mandrel after step e) to form the inner cavity, wherein the inner cavity substantially extends from a grip end of the shaft to an outer end of the functional head section, and g) providing the inner cavity with at least one weight distributing element of which a cross-sectional dimension is about equal to a cross-sectional dimension of the inner cavity, wherein the at least one weight distributing element has a relatively low stiffness to be able to accommodate a curvature in the elongated article.

32. The method according to claim 31, wherein the core mandrel is provided with at least one shaping element before overlaying the first reinforcing fibers.

33. The method according to claim 31, wherein the core mandrel is provided with an internal part that when removed forms a well defined inner cavity.

34. The method according to claim 31, wherein overlaying with the first and/or second reinforcing fibers is performed by in situ braiding the reinforcing fibers onto the core mandrel or overlaid core mandrel.

35. The method according to claim 34, wherein the in-situ braiding is performed from a grip end of the shaft to an outer end of the functional head section and/or vice versa.

36. The method according to claim 31, wherein the core mandrel has a constant cross-section along the elongated article.

37. The method according to claim 36, wherein the cross-section of the core mandrel is rectangular.

38. The method according to claim 31, wherein the functional head section of the elongated article comprises a contacting surface, and a first wall part extends perpendicular to said contacting surface.

39. The method according to claim 31, wherein weight distributing elements are interconnected to form a string of interconnected weight distributing elements.

40. The method according to claim 31, wherein a cross-sectional dimension of the at least one weight distributing element is about equal to a cross-sectional dimension of the inner cavity.

41. The method according to claim 40, wherein the cross-section of the at least one weight distributing element is about equal to the cross-section of the inner cavity.

42. The method according to claim 31, wherein the weight distributing elements in the string are interconnected through a hook-like connection.

43. The method according to claim 42, wherein the hook-like connection is obtained by interlocking cantilevered end sections of adjacent weight distributing elements.

44. The method according to claim 31, wherein a part of the at least one weight distributing element is slightly oversized with respect to the cross-section of the inner cavity.

45. The method according to claim 31, wherein the at least one weight distributing element extends from a grip end of the shaft to an outer end of the functional head section.

46. The method according to claim 31, wherein weight distributing elements with a different density and/or shape are provided in the inner cavity.

47. The method according to claim 31, wherein the at least one weight distributing element comprises a stack of lamellae.

48. The method according to claim 31, wherein the matrix material comprises a thermosetting resin that is consolidated by curing.

49. The method according to claim 31, wherein the matrix material comprises a thermoplastic polymer that is consolidated by cooling.

50. The method according to claim 31, wherein the elongated article comprises a field hockey stick, an ice hockey stick or a cricket stick, preferably a field hockey stick.

51. An elongated curved article, obtainable by a method according to claim 31, comprising a shaft and a functional head section, and a well defined inner cavity, wherein the inner cavity substantially extends from a grip end of the shaft to an outer end of the functional head section, and wherein the inner cavity is provided with at least one weight distributing element of which a cross-sectional dimension is about equal to a cross-sectional dimension of the inner cavity, wherein the at least one weight distributing element has a relatively low stiffness to be able to accommodate a curvature in the elongated article, and wherein dimensions of the inner cavity do not deviate between cross-sections of the elongated article by more than 10%, more preferably by more than 5%, and most preferably by more than 2%.

52. The elongated curved article according to claim 51, wherein the elongated article comprises a field hockey stick, an ice hockey stick or a cricket stick.

53. The elongated curved article according to claim 52, wherein the elongated article comprises a field hockey stick.
